(19) United States
(12) Patent Application Publication
(10) Pub. No.: US 2010/0088111 A1
(43) Pub. Date: Apr. 8, 2010

(54) SYSTEM AND METHOD FOR OBTAINING, PROCESSING AND EVALUATING INDIVIDUAL BLOOD TYPE AND AYURVEDIC CORE CONSTITUTION (PRAKRUTI) TO CONSTRUCT A PERSONALIZED HEALTH RISK ASSESSMENT REPORT

(76) Inventors: Steven W. Bailey, Placerville, CA (US); Janet M. Bailey, Placerville, CA (US)

Correspondence Address: DLA PIPER LLP US, P. O. BOX 2758, RESTON, VA, 20195, US

(21) Appl. No.: 12/570,116

(22) Filed: Sep. 30, 2009

Related U.S. Application Data
(60) Provisional application No. 61/101,539, filed on Sep. 30, 2008.

(51) Int. Cl. G06Q 50/00; G06F 17/30

(52) U.S. Cl. 705/2; 707/822; 707/E17.009

(57) ABSTRACT

A computer-based system and method is disclosed which constructs a personalized health risk assessment report by direct interactions between the individual and system that acquires pertinent and relevant personal information covering the blood type and Ayurvedic core constitution of a given individual. The system and method of the present invention enable an accurate personalized assessment to be generated for every individual interacting with the system. Once acquired, the facts of the individual's blood type and Ayurvedic core constitution are analyzed automatically by the database to identify a subset of potential health risks and weaknesses within the primary physical and emotional systems of the individual for each potential risk factor for disease that is uncovered in the database. Further, the automatically analyzed database of potential risk factors is used as the search tool for bringing to bear, on the discovery for each potential risk factor identified in each individual, a wealth of health and wellness knowledge that relates to and can be useful for correct and efficient recommendations for each of every individual's potential risks and weaknesses. This collection of information is analyzed to generate a final health risk assessment report of primary physical and emotional systems the individual may need to be aware of, potential risks and weaknesses within those identified systems, and dietary, nutritional and supplemental recommendations to bring into and maintain balance within those identified systems.

The information age has provided many pluses with regard to the amount and quality of information available to everyone. This is especially true in the health care industry because individuals now have access to large quantities of data on any subject in a short amount of time. With the rapidly rising cost of medical care, individuals are attempting to discover relevant information on their own in an effort to improve their health. However, without a clearly defined personalized set of potential risks and weaknesses, individuals do not have enough information to know exactly what to look for nor exactly what actions to take to improve or maintain their health. Taking the appropriate actions for a specific risk for a specific individual requires an ability to tailor this access to the vast amount of health and wellness knowledge based on the specific blood type and Ayurvedic core constitution of a particular individual. This type of tailoring, if it was available, would be of great help, would save time and money. More specifically, this tailoring would reduce the time needed to reach, and the uncertainty surrounding, decisions about preventative health care and would improve the quality of health care so that individuals were always armed with the personalized knowledge required to identify and proactively address each specific risk and weakness of said individual.

The foregoing, if available, would result in an overall increase in the health and wellness of the population by making individuals more aware of their own potential risks and weaknesses, and recommending action plans for the improvement and maintenance of their health. It would also enhance the quality of care given to individuals as they become more knowledgeable about their own health and wellness.

The considerations referred to above will require re-engineering the current health care system to increase its efficiency. When this is done, it will overcome the endemic problems in the system which have been widely acknowledged to include: high and escalating costs of health care in the United States and worldwide, and lack of a uniform quality of care in all areas where health care is administered. There also are serious problems in the ability of the health care system to address emerging issues in health care in more than a purely localized way. Physicians, for example, are under pressure to increase the number of patients that they see and also reduce the time spent with each individual patient. This, among other things, results in an erosion in the physician-patient relationship. This, in part, is based on physicians having little time to assess patient needs, develop the most correct and efficient plans for treatment, or establish a rapport with the patient.

A review of typical medical practice habits indicates that medicine today is far more reactive than proactive. Most patients seek health care only when they feel ill, leading to a reactive system of disease identification, treatment and management. An important facet of the physician-patient interaction that suffers when physicians have less time to spend with patients is the reduction in the amount of information that patients learn about their disease. This will include the nature of their disease, the importance of treatment compliance, and patient activities that can control the outcome of their illness, to name a few. On the other hand, patients would be far better served with a preventative system of medicine, one of early risk identification and prevention. Patients could arm themselves with an incredible amount of personalized knowledge before visiting with their physician, resulting in a much more effective physician-patient encounter.

The present invention overcomes the problems set forth above as will be described in the remainder of the specification referring to the drawings.

### SUMMARY OF THE INVENTION

The present invention is a centrally deployed, computer-based system and method that may be coupled with analytic systems and databases. This system and method uses a global communication system, e.g., the Internet, to acquire, analyze, and store all relevant facts about all individuals interacting with the system.

The system and method of the present invention generates a personalized health risk assessment report that identifies the primary physical and emotional systems an individual should be aware of, the potential risks and weaknesses within those systems, and provides dietary, nutritional and supplemental recommendations that can be used preventatively as well as for treatment.

The system and method of the present invention includes, as a component, an expert system that uses the data entered into the individual's database to automatically and continuously compare the risks and weaknesses and the recommendations for each individual versus individuals with similar blood type and Ayurvedic core constitution profiles. Therefore, as changes occur in the data, there will be appropriate changes and recommendations to the individual so that better prevention regimens may be provided to the individual.

The system and method of the present invention provides a method and system for studying an entire population at risk in a real-time, real world setting in which individuals at risk live and are treated. This differs from conventional methods that consist of the highly controlled, idealized settings of clinical research trials. The system and method of the present invention are capable of determining the incidences of different risks and weaknesses across populations on a region-wide, country-wide or worldwide basis, and rapidly assess changes in such trends.

The history component of the present invention is intended for use by the system to further identify potential risks and weaknesses. The family history that is taken according to the present invention is akin to one taken by an expert physician. The family history allows an individual to identify medical conditions of their immediate relatives as known by the individual. The history component of the present invention is structured on the basis that historical medical information may be relevant to the patient's health.

The system and method of the present invention, is further distinguished from current and known systems by the following:

The system and method of the present invention includes a graphical user interface (“GUI”). It is through use of the GUI that individual information is acquired. It is also through use of the GUI that information is gathered and a determination may be made, for example, of the potential risks and weaknesses of the individual.

The system and method of the present invention describes a system that has the ability to integrate the environmental and lifestyle factors for a given individual. The system and method of the present invention also has the ability to integrate other medical data besides the information identified above to further increase the accuracy of the resulting personalized health risk assessment report.

Further, the system and method of the present invention allows for updating the programs that acquire the individual information as changes occur in the fundamental base of knowledge that improves the practice of health care. The system and method of the present invention provides the individual with an understanding of the risk factors identified by the acquisition of the information over which the individual has control.

The system and method of the present invention automatically incorporates and integrates collected data in the individual's complete database. This includes, but is not limited to, a risk assessment, follow-up risk assessment, response to prevention measures or lack thereof, all other medical and historical data, and automatically analyzing any data acquired in the full context of the complete individual health and wellness information.

The system and method of the present invention need not make assumptions in order to analyze the significance of any feature in the database. The basic analytic systems of the present invention are not limited to data acquired by clinical testing, that is numeric, or that is analyzed by statistical methods. Additionally, the application of statistical methods to analysis of the databases generated by the present invention is not limited to data that is acquired by clinical testing or that is numerical in nature.

The system and method of the present invention will be described in greater detail in the remainder of the specification referring to the drawings.

### BRIEF DESCRIPTION OF THE DRAWINGS

FIG. 1 is a block diagram of the system of the present invention.

FIG. 2 is an example screen shot of the first data input form containing personal information.

FIG. 3 is an example screen shot of the second data input form containing Ayurvedic core constitution indicators and possible selections.

FIG. 4 is an example screen shot of the second data input form containing Ayurvedic core constitution indicators and possible selections with tie-breaker question.

FIG. 5 is a diagram of the operation of system processor 104 in FIG. 1.

FIG. 6 is a sample portion of the data table containing all potential information for all blood types and all Ayurvedic Prakruti.

FIG. 7 is a sample health risk assessment report showing report categories.

### DETAILED DESCRIPTION OF THE INVENTION

The present invention is a computer-based system and method which constructs a personalized health risk assessment report by direct interactions between the individual and the system that acquires pertinent and relevant personal information covering the blood type and Ayurvedic core constitution of a given individual. The system and method insure that an accurate personalized assessment is generated for every individual interacting with the system. Once acquired, the facts of the individual's blood type and Ayurvedic core constitution are analyzed by the database to identify a subset of potential health risks and weaknesses within the primary physical and emotional systems of the individual for each potential risk factor for disease that is uncovered in the database. Further, the analyzed database of potential risk factors is used as the search tool for bringing to bear, on the discovery for each potential risk factor identified in each individual, a wealth of health and wellness knowledge that relates to and can be useful for correct and efficient recommendations for each of every individual's potential risks and weaknesses. This collection of information is analyzed to generate a final report of primary physical and emotional systems the individual should be aware of, potential risks and weaknesses within those systems, and recommendations to bring into and maintain balance within those identified systems.

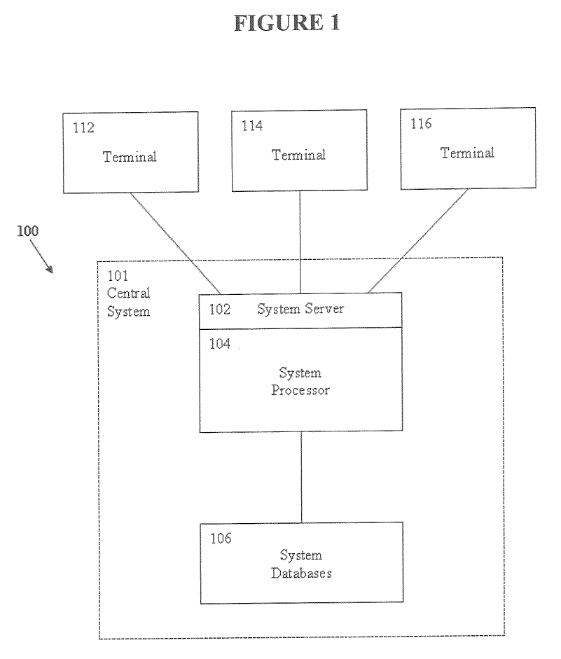

FIG. 1, at 100, shows a block diagram of the system of the present invention. The system may be implemented in a large area network (“LAN”), a wide area network (“WAN”), a metropolitan area network (“MAN”) or an Internet-based system. The system includes system server 102, which serves as the connection point for system users. System processor 104 connects to system server 102. The system processor includes system programming and security recognition technology systems.

System database 106 connects to system processor 104. It is also understood that this database is representative of the system database and that such database may contain other types or categories of information and still be within the scope of the present invention. For example, and without limitation, system database 106 may contain information related to an individual's location, such as state and country.

System server 102, system processor 104 and system database 106 form central system 101 of the present invention. It is understood that the present invention may have the central system that is configured differently and still be within the scope of the present invention. For example, the central system may have two or more system separate servers that are interconnected, a plurality of processors for carrying out discrete functions, one or more central databases, include different types of memory structures, e.g., cache memories, or connected peripherals.

Again referring to FIG. 1, terminals 112, 114, and 116 are shown. These terminals may be used by individuals to input data into, or retrieve information from, the system databases. A terminal may be located at any appropriate site where individual information may be input or retrieved, or where an individual would desire to obtain educational information from the discovery of personalized health and wellness information.

Terminals 112, 114, and 116 connect to system server 102. It is understood that the system of the present invention may include any number terminals and still be within the scope of the present invention. Individuals may access system database 106 only through server 102 or its equivalent.

A representative method of the present invention for obtaining and storing pertinent and relevant personal information covering the blood type and Ayurvedic core constitution of a given individual will now be discussed referring to FIG. 1.

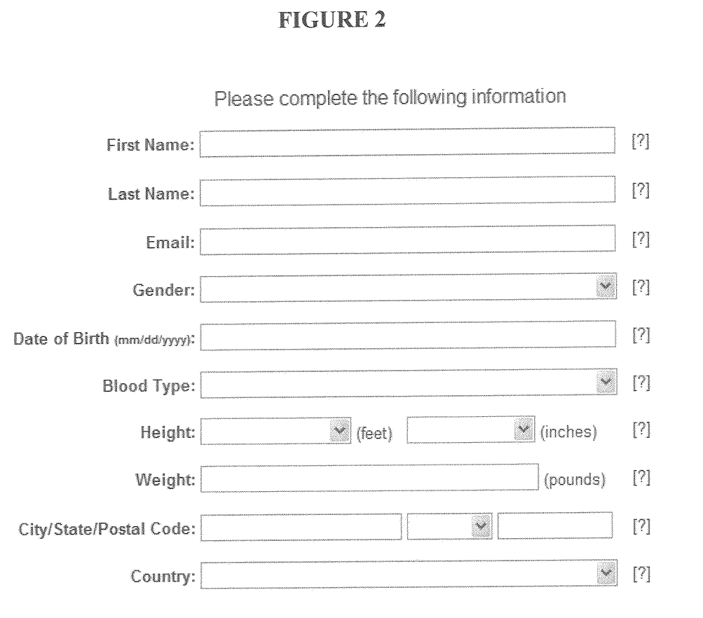

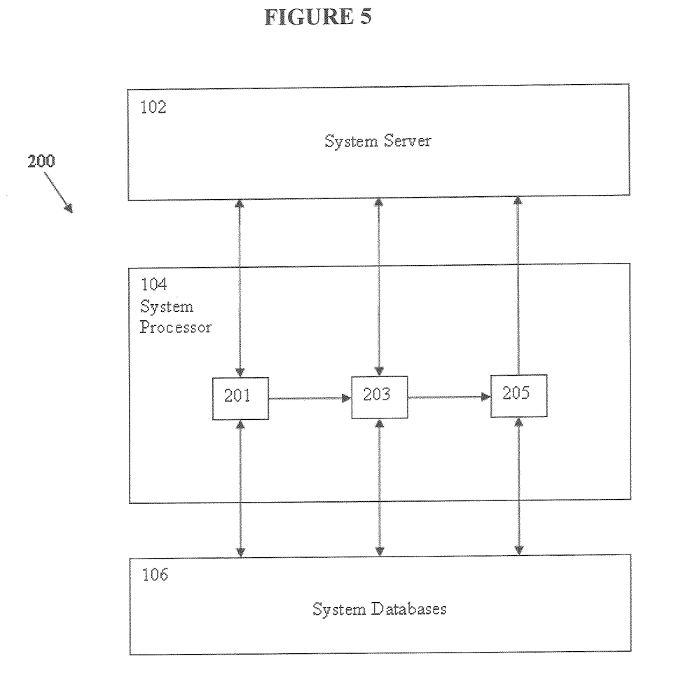

An individual connects to the central system via a terminal, for example, terminal 112, which requests information from the system server 102. System server 102 requests from system processor 104 the first data input form which will allow the individual to input personal information. The system processor 104 accesses system database 106 to acquire the appropriate information to fulfill the first data input form request from system server 102. The first data input form is then returned to the terminal 112 and displayed in a human readable GUI format, for example using HTML as shown in FIG. 2. The individual then provides personal information from terminal 112, including but not limited to the individual's e-mail address, first and last name, date of birth, gender, blood type, height, weight and home location. The individual's personal information is then sent from terminal 112 to system server 102, which in turn passes it to system processor 104. System processor 104 accesses system database 106 to insure that all required information was sent from terminal 112 and that the information sent from terminal 112 follows the rules of validation as detailed in FIG. 5.

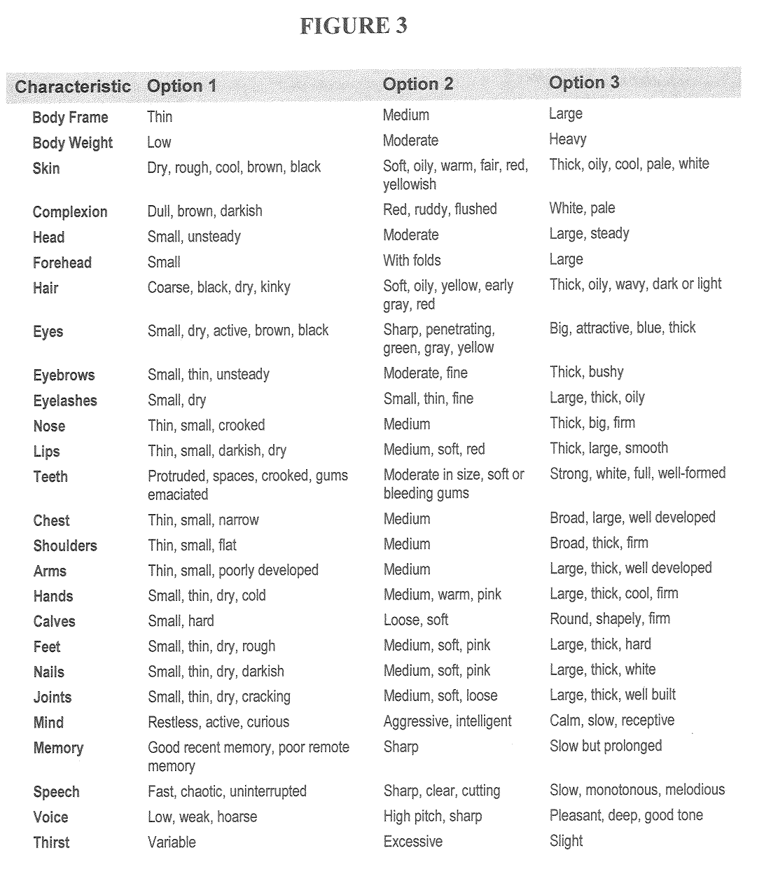

Once the system processor 104 has determined that the personal information provided from terminal 112 is complete and valid, system processor 104 saves into database 106 the personal information provided by the individual from terminal 112. System database 106 creates a unique identifier to allow subsequent processes to access the newly saved information. Once the unique identifier has been created by system database 106, system processor 104 accesses system database 106 to acquire the appropriate information to generate the second data input form, consisting of a multiple choice list of Ayurvedic core constitution indicators. The second data input form is then returned to the terminal 112 and displayed in a human readable GUI format, for example using HTML as shown in FIG. 3.

In the current state of the present invention, each Ayurvedic core constitution indicator has three options, with each option directly related to a specific Ayurvedic Prakruti, identified in Ayurvedic terms as Vatta, Pitta, and Kapha. The Ayurvedic Prakruti terms can be identified in equivalent terms from the medical model as ectomorph, mesomorph, and endomorph respectively. Each Ayurvedic core constitution indicator requires a selection from the individual of one and only one of the three possible options.

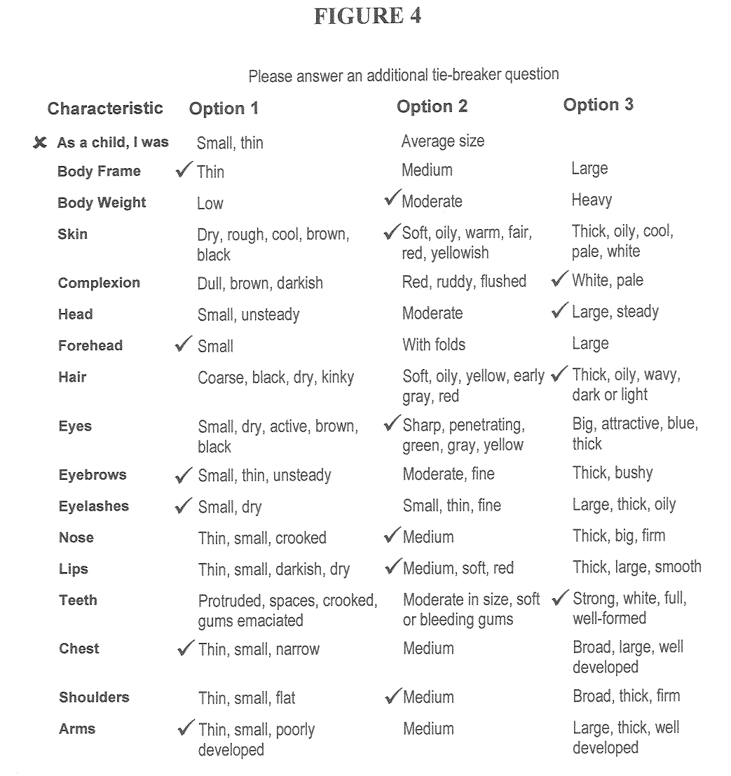

Once a response has been recorded from the individual for all Ayurvedic core constitution indicators, the individual's Ayurvedic core constitution indicator selections, as shown in the example using HTML in FIG. 4, are then sent from terminal 112 to system server 102, which in turn passes them to system processor 104. System processor 104 accesses system database 106 to insure that all required information was sent from terminal 112 and that the information sent from terminal 112 follows the rules of validation as detailed in FIG. 5.

Once the system processor 104 has determined that the Ayurvedic core constitution indicator selections provided from terminal 112 are complete and valid, system processor 104 saves into system database 106 the Ayurvedic core constitution indicator selections provided by the individual from terminal 112. System processor 104 then determines the number of selections for each Ayurvedic Prakruti. If system processor 104 determines that two or more Ayurvedic Prakruti have the same number of selections and no other Ayurvedic Prakruti has a higher number of selections, system processor 104 adds an additional tie-breaker question to the list of Ayurvedic core constitution indicators and sends the new list of Ayurvedic core constitution indicators along with the selections provided by the individual to terminal 112, which displays the new list of Ayurvedic core constitution indicators and the individual selections in a human readable GUI format, for example using HTML as shown in FIG. 4.

Historically, Ayurveda allows individuals to be identified by more than one Ayurvedic Prakruti, for example Vata-Pitta or Vata-Kapha, meaning that the individual has an equal number of characteristics from both Ayurvedic Prakruti and more than the third Ayurvedic Prakruti. However, the current state of the present invention requires the individual to further narrow the Ayurvedic core constitution indicator selections by adding a tie-breaker question that only allows selecting from one of the Ayurvedic Prakruti containing the same number of Ayurvedic core constitution indicator selections. This requirement allows the individual to make a decision based upon the individual's own belief as to their core constitution as a child, allowing the analysis of the present invention to more precisely narrow the subset of information from the total set of information stored in system database 106.

Once a response has been recorded from the individual for the tie-breaker question and all other Ayurvedic core constitution indicators, the individual's Ayurvedic core constitution indicator and tie-breaker selections are sent from terminal 112 to system server 102, which in turn passes them to system processor 104. System processor 104 accesses system database 106 to insure that all required information was sent from terminal 112 and that the information sent from terminal 112 follows the rules of validation as detailed in FIG. 5. Once the system processor 104 has determined that the Ayurvedic core constitution indicator and tie-breaker selections provided from terminal 112 are complete and valid, system processor 104 saves into system database 106 the Ayurvedic core constitution indicator and tie-breaker selections provided by the individual from terminal 112. It is possible for the individual to cause a tie in the number of Ayurvedic core constitution indicator selections, even including the tie-breaker selection. For example, if the implementer of my invention provides that the original selections that caused the tie in the first place are not locked, the user can change any or all selections, including the tie-breaker question, leading to another tie. While this may be unlikely, it can happen. To solve for this eventuality, the second data entry form can continue to be displayed with the Ayurvedic core constitution and tie-breaker indicators, along with the current Ayurvedic core constitution and tie-breaker indicator selections until selections within one and only one of the three possible Ayurvedic Prakruti contains more selections than either of the other two. In other words, there should be only one Ayurvedic Prakruti containing the highest number of Ayurvedic core constitution indicator and tie-breaker selections.

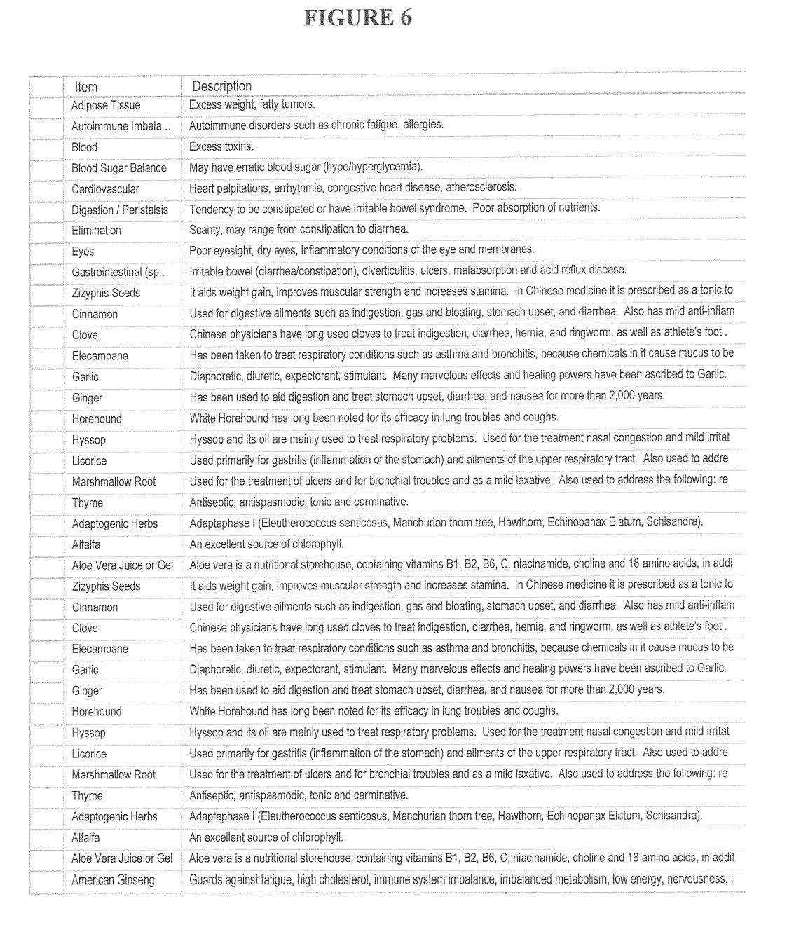

After system processor 104 has determined that the Ayurvedic core constitution indicator selections provided from terminal 112 are complete and valid, and that only one of the three possible Ayurvedic Prakruti contains more selections than either of the other two, system processor 104 accesses system database 106 providing the blood type specified by the individual and the Ayurvedic Prakruti with the highest number of selections as determined by system processor 104 by counting the total number of selections for each possible Ayurvedic Prakruti. In the current state of the present invention, system database 106 returns a union of the specific sets of information stored in system database 106 for the specified blood type and Ayurvedic Prakruti from the total possible sets of information stored in system database 106 for all blood types and all Ayurvedic Prakruti, as shown in the sample data table in FIG. 6.

In the current state of the present invention, the union of specific sets of information stored in system database 106 for specific blood type and Ayurvedic Prakruti consists of, but is not limited to, primary physical systems at risk of imbalance, primary emotional systems at risk of imbalance, potential risks and weaknesses for disease or imbalance, dietary recommendations, nutritional recommendations, supplemental recommendations and homeopathic recommendations.

FIG. 5, at 200, shows a diagram of the operation of system processor 104 shown in FIG. 1. These operations will be described in a manner that will show how the system of the present invention controls the processing of information among the system processes and system databases.

System process 201 interacts with system server 102 and system database 106 to build the first data input form which allows the individual to input personal information. The initial request from system server 102 to system process 201 causes system process 201 to access system database 106 to retrieve information necessary to generate a data input form and return it to system server 102 in a human readable GUI format, for example using HTML as shown in FIG. 2. The data input form created by system process 201 consists of but is not necessarily limited to, first and last name, email address, gender, blood type, height, weight and home location. In the current state of the present invention, only gender, blood type and portions of home location are built from information stored in system database 106.

Once the individual has entered all the requested information, system server 102 passes the data input form information back to system process 201. System process 201 verifies that all required information has been entered in valid formats appropriate to the data input field type, for example a date value for the date of birth field or a numeric value for the weight field.

Once the information provided has been verified as complete and valid, system process 201 accesses system database 106 to save provided information. System database 106 generates a unique identifier upon a successful save of the provided information and returns it to system process 201. System process 201 then passes control and the unique identifier to system process 203 for the next step.

System process 203 interacts with system server 102 and system database 106 to build the second data input form which allows the individual to specify selections for Ayurvedic core constitution indicators. Upon receiving the unique identifier created by system database 106 from system process 201, system process 203 accesses system database 106 to retrieve information necessary to generate a data input form and return it to system server 102 in a human readable GUI format, for example using HTML as shown in FIG. 3. The data input form created by system process 203 consists of all Ayurvedic core constitution indicators stored in system database 106. Each Ayurvedic core constitution indicator has three possible selections corresponding to each of the three Ayurvedic Prakruti, which are also stored in system database 106 along with the Ayurvedic core constitution indicators, as can be seen in the HTML example shown in FIG. 3.

Once the individual has entered all the requested information, system server 102 passes the data input form information back to system process 203. System process 203 verifies that all Ayurvedic core constitution indicators have one and only one Ayurvedic Prakruti selection from the three possible Ayurvedic Prakruti selections. After verifying that all Ayurvedic core constitution indicators have only one Ayurvedic Prakruti selection, the number of selections for each Ayurvedic Prakruti are counted. If the top two or three Ayurvedic Prakruti have the same number of Ayurvedic core constitution indicator selections, system process 203 rebuilds the data input form with an additional tie-breaker question and returns the newly built data input form and the individual Ayurvedic core constitution indicator selections back to system server 102 in a human readable GUI format, for example in HTML as shown in FIG. 4. The process in this paragraph continues until one and only one Ayurvedic Prakruti has the highest number of Ayurvedic core constitution indicator selections.

Once the Ayurvedic core constitution indicator selections have been verified as complete and valid as defined in the preceding paragraph, system process 203 accesses system database 106 to save the Ayurvedic core constitution indicator and tie-breaker selections. System process 203 then passes control to system process 205 for the next step.

System process 205 interacts with system database 106 to build the health risk assessment report, which is subsequently returned to system server 102. Using the unique identifier created by system process 201, system process 205 access system database 106 to retrieve the individual's personal information and the individual's Ayurvedic core constitution indicator and tie-breaker selections, as shown by examples in FIG. 2 and FIG. 3. System process 205 then counts the number of Ayurvedic core constitution indicator selections for each Ayurvedic Prakruti, as previously described.

System process 205 accesses system database 106 using the individual's blood type and the Ayurvedic Prakruti with the highest number of Ayurvedic core constitution indicator selections to retrieve the subset of information directly related to the specified blood type and Ayurvedic Prakruti from the total set of possible information related to all blood types and Ayurvedic Prakruti stored in system database 106. The total set of possible information related to all blood types and Ayurvedic Prakruti consists of, but is not limited to, the identification of the primary physical systems, the identification of the primary emotional systems, the identification of all possible potential risks and weaknesses, the identification of dietary recommendations, the identification of nutritional recommendations, the identification of supplemental recommendations, the identification of homeopathic recommendations, as shown in the sample data table in FIG. 6.

Each different blood type results in a separate subset of information from the total set of information stored in system database 106. Each different Ayurvedic Prakruti results in a separate subset of information from the total set of information stored in system database 106. The union of the subset of information for a specific blood type with the subset of information for a specific Ayurvedic Prakruti results in a unique limited subset of information from the total information available in system database 106.

In the current state of the present invention, system database 106 returns to system process 205 the union of the subset of information for the specified blood type with the subset of information for the specified Ayurvedic Prakruti, resulting in a unique limited subset of information from the total information available in system database 106. The unique limited subset of information related to the specified blood type and Ayurvedic Prakruti consists of, but is not limited to, the identification of the primary physical systems, the identification of the primary emotional systems, the identification of all possible potential risks and weaknesses, the identification of dietary recommendations, the identification of nutritional recommendations, the identification of supplemental recommendations, the identification of homeopathic recommendations, as shown by the data table sample in FIG. 6.

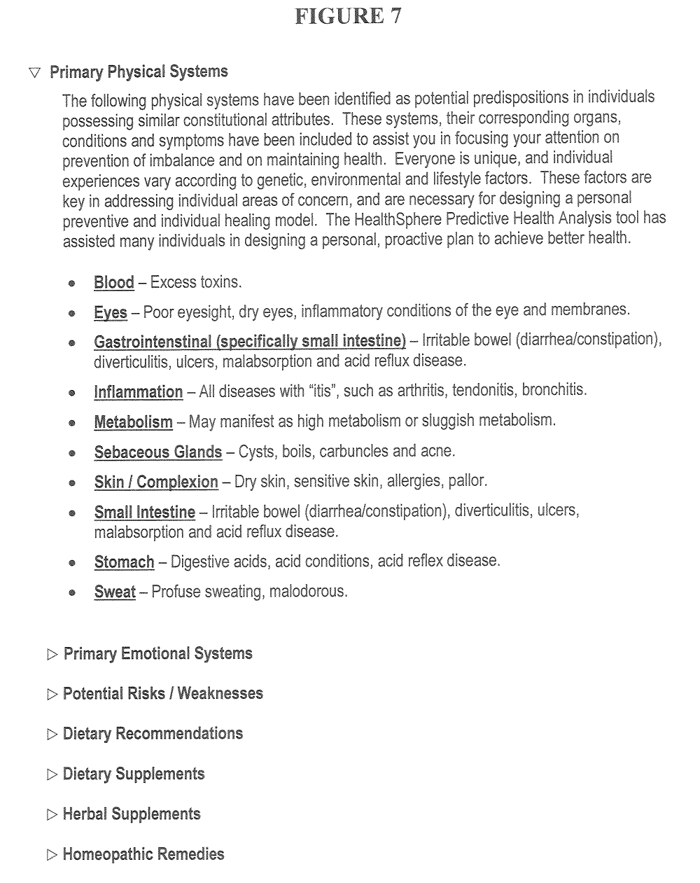

From the information returned to system process 205 by system database 106 as specified in the preceding paragraph, system process 205 generates a health risk assessment report and returns it to system server 102 in a human readable GUI format, for example in HTML as shown in FIG. 7.

The terms and expressions that are employed herein are terms of description and not of limitation. There is no intention in the use of such terms and expressions of excluding the equivalents of the feature shown or described, or portions thereof, it being recognized that various modifications are possible within the scope of the invention as claimed.

I claim:

1. A computer-based method and system for use by individuals for obtaining, processing and evaluating blood type and Ayurvedic core constitution, comprising the steps of:
(a) the individual inputting personal information;
(b) the system validating the information input by the individual at step (a);
(c) the system storing the information validated at step (b) into a central database and generating a unique identifier;
(d) the individual answering a set of questions used to determine Ayurvedic core constitution, or Ayurvedic Prakruti;
(e) the system validating the responses to the questions answered by the individual at step (d);
(f) the system storing the information validated at step (e) into a central database;
(g) rule-based calculations with a computer in an automated manner to determine the individual Ayurvedic Prakruti based upon the responses at step (d);
(h) selecting with a computer a subset of information based upon blood type saved at step (c) from the total set of information for all blood types, together with a subset of information based upon the Ayurvedic Prakruti calculated at step (g) from the total set of information for all Ayurvedic Prakruti;
(i) retrieving in an automated manner from the subsets of information selected at step (h);
(j) rule-based combination with a computer in an automated manner the information retrieved at step (i);
(k) generating with a computer in an automated manner a health risk assessment report for an individual including at least a set of possible risks and weaknesses based on specific blood type and calculated Ayurvedic Prakruti, and including as part of the report specific, relevant and up-to-date recommendations for diet, nutrition and supplementation.

2. The method as recited in claim 1, wherein the input at step (a) includes a blood type known to the individual.

3. The method as recited in claim 2, wherein a portion of the generated health risk assessment report is based on the blood type.

4. The method as recited in claim 1, wherein the responses at step (d) are accurate selections based upon the knowledge of the individual.

5. The method as recited in claim 1, wherein a portion of the generated health risk assessment report is based on the Ayurvedic Prakruti calculated from the responses as recited in claim 4.

6. The method as recited in claim 1, wherein the method processes with a computer the information obtained in claims 2 and 4.

7. The method as recited in claim 1, wherein the method generates with a computer a health risk assessment report based upon the information in claims 3 and 5.

8. The method as recited in claim 1, wherein the health risk assessment information includes primary physical systems.

9. The method as recited in claim 1, wherein the health risk assessment information includes primary emotional systems.

10. The method as recited in claim 1, wherein the health risk assessment information includes risk factors for systems recited in claims 6 and 7.

11. The method as recited in claim 1, wherein the health risk assessment recommendations include dietary information.

12. The method as recited in claim 1, wherein the health risk assessment recommendations include nutritional information.

13. The method as recited in claim 1, wherein the health risk assessment recommendations include supplemental information.

14. The method as recited in claim 1, wherein the health risk assessment recommendations include homeopathic information.

15. A computer-based method for delivering an accurate health risk assessment report.

16. The method according to claim 15, wherein the method is implemented by the individual responding to a series of data input forms and questionnaires.

17. The method according to claim 16, wherein the method may be implemented via a computer-based network.

18. The method according to claim 16, wherein the method may be implemented via the Internet.
